(19) United States
(12) Patent Application Publication
(10) Pub. No.: US 2012/0154168 A1
(43) Pub. Date: Jun. 21, 2012

(54) PHOTONIC CRYSTAL WAVEGUIDE DOWNHOLE COMMUNICATION SYSTEM AND METHOD

(75) Inventors: Roger G. Duncan, Christiansburg, VA (US); Darrin L. Willauer, The Woodlands, TX (US); Alexander M. Barry, Roanoke, VA (US); Robert M. Harman, Troutville, VA (US)

(73) Assignee: BAKER HUGHES INCORPORATED, Houston, TX (US)

(21) Appl. No.: 12/970,331

(22) Filed: Dec. 16, 2010

(51) Int. Cl. G01V 3/12

(52) U.S. Cl. 340/854.7

(57) ABSTRACT

A downhole component includes a body portion and a photonic crystal waveguide coupled to the body portion that is configured to receive a signal from a device.

### BACKGROUND OF THE INVENTION

1. Field of the Invention

The present invention relates to communication and, in particular, to communication with devices in a borehole.

2. Description of the Related Art

In drilling and completion industries it is often necessary to drill a borehole into the earth to gain access to the hydrocarbons. Equipment and structures, such as borehole casings for example, are generally disposed in a borehole as part of the completion. Unfortunately, the environment presented deep within the borehole can place extreme demands upon the devices and structures disposed therein. For example, the devices and structures can be exposed to high temperatures and pressures that can affect their operation and longevity.

Several different methods have been utilized to communicate with the devices located either permanently or temporarily in the borehole. One approach has been to provide for communication over optical fiber. Another approach has been to communicate over electrical wires either within the drill string (e.g., wired pipe) or within a wireline. Still another approach has been to utilize mud-pulse telemetry systems.

There have also been numerous attempts to create a system that allows for wireless communication between the devices in a borehole and a surface location. Some of them work better than others.

### BRIEF SUMMARY OF THE INVENTION

In one embodiment, a communication system for communicating between a device in a borehole penetrating a subsurface formation and a computing device at a surface location is disclosed. The system of this embodiment includes a downhole component having a portion near the device and a photonic crystal waveguide coupled to the downhole component that is configured to receive a signal from the device and guide it towards the computing device.

According to another embodiment, a method of communicating from a downhole device located in a borehole penetrating a subsurface formation to a surface location is disclosed. The method of this embodiment includes coupling an electromagnetic (EM) signal from the device to a photonic crystal waveguide; guiding the EM signal through the photonic crystal waveguide in a direction away from the device and towards the surface location; converting the EM signal to a digital signal; and providing the digital signal to a computing device at the surface location.

In yet another embodiment, a method of communicating from a computing device at a surface location to a downhole device located in a borehole penetrating a subsurface formation is disclosed. The method of this embodiment includes converting a digital signal created by the computing device into an electromagnetic signal; coupling an electromagnetic (EM) signal to a photonic crystal waveguide; guiding the EM signal through the photonic crystal waveguide in a direction away from surface location and towards the device; receiving the EM signal at the device.

In another embodiment, a downhole component is disclosed. The downhole component of this embodiment includes a body portion and a photonic crystal waveguide coupled to the body portion, the photonic crystal waveguide configured to receive a signal from a device.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates a perspective view of a photonic crystal waveguide (PCW) according to one embodiment;

FIG. 2 shows a downhole communication system according to one embodiment,

FIG. 3 shows a downhole communication system according to another embodiment;

FIG. 4 shows a perspective view of a PCW coupled to a downhole component;

FIG. 5 illustrates a leak region between downhole components;

FIG. 6 illustrates a leak region between a downhole component and a device; and

FIG. 7 shows an example of a computing system on which embodiments of the present invention may be implemented.

### DETAILED DESCRIPTION OF THE INVENTION

According to one embodiment of the present invention, a downhole component such as, for example a drill string segment or a portion of casing, includes a waveguide formed of photonic crystals coupled thereto. In one embodiment, the waveguide is configured to guide radio or microwave frequencies from a downhole device towards the surface or from the surface towards a downhole device, or both.

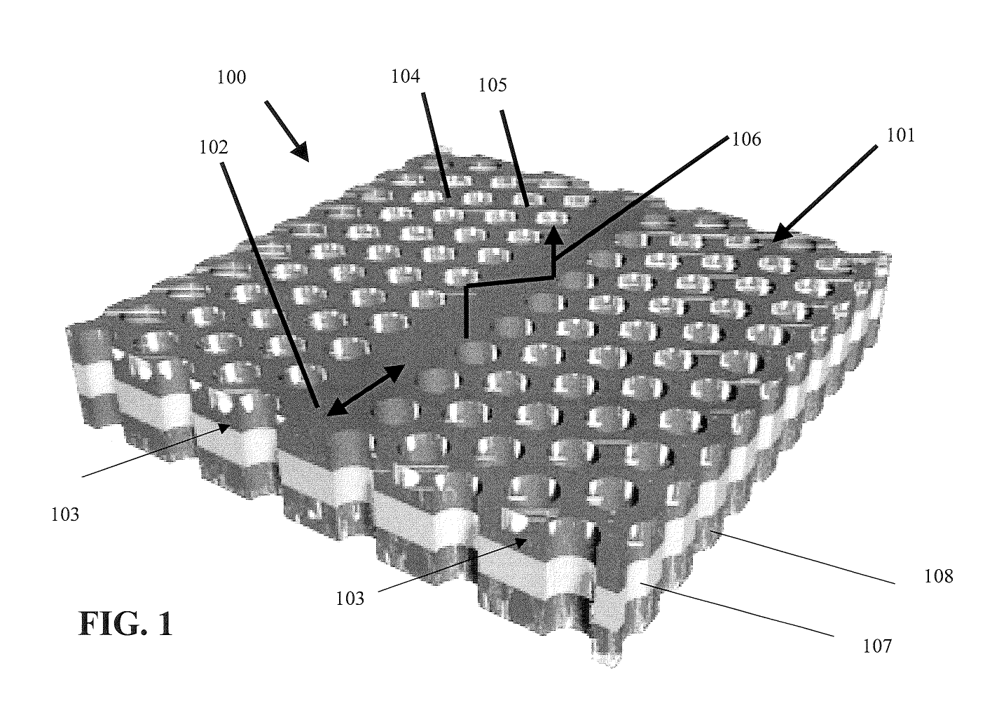

FIG. 1 shows a perspective view of an example of photonic crystal waveguide 100 according to one embodiment. The photonic crystal waveguide 100 is formed of a photonic crystal 101 in one embodiment. As illustrated, the photonic crystal 101 includes a guide region 102 having blocking regions 103 disposed on either side thereof. In operation, electromagnetic waves (EM) are guided in either direction along the guide region 102.

A photonic crystal contains regularly repeating internal regions of high and low dielectric constant. Photons (behaving as waves) propagate through this structure—or not—depending on their wavelength. Wavelengths of light that are allowed to travel are known as modes, and groups of allowed modes form bands. Disallowed bands of wavelengths are called photonic bandgaps. As such, a particular wavelength is not allowed to pass through a photonic crystal if it is within the photonic bandgap. This property will cause photons having a wavelength in the photonic bandgap to be reflected at a boundary where the spacing of dielectric symmetry changes (i.e., where the bandgaps change).

In FIG. 1, in the blocking regions 103 the photonic crystal 101 includes regularly repeating internal regions of high dielectric constant (illustrated as flat surface 104) and low dielectric constant (illustrated as holes 105). It shall be understood that the flat surface 104 could have a lower dielectric constant than the holes 105 in one embodiment. In such an embodiment, the flat surface 104 could be a substrate and the holes 105 could be implemented as rods displaced in the flat surface 104.

As illustrated, the guide region 102 does not include holes 105. Of course, the guide region could be formed by varying the location and spacing of the holes or by otherwise varying the dielectric symmetry the waveguide 100 to form the guide region 102. Regardless of how formed, the guide region 102 is configured to allow photons of at least one wavelength to travel through it. In one embodiment, the guide region is configured to transmit EM radiation in the radio or microwave frequency ranges. Similarly, in one embodiment, the blocking regions 103 include holes 105 or other nanostructures spaced and arranged such they do not allow EM radiation in the range that the guide region 102 is configured to transmit to enter them. As such, the blocking regions 103 serve to reflect the EM radiation back and forth between them in a particular direction of travel (based on the launch angle of the EM radiation) as illustrated by arrow 106. Of course, the direction of travel could be in the opposite direction in one embodiment. It shall be understood that total internal reflection may constrain the EM radiation within the guide region 102 at the junction between the guide region 102 and another material or air.

In one embodiment, the photonic crystal 101 is formed of a high-dielectric material (e.g. RT/Duriod 6010.2) having holes 105 formed in the blocking regions 103. In another embodiment, the flat surface 104 is a metal and the “holes” 105 are a material having a higher dielectric constant that the metal.

In FIG. 1, flat surface 104 is separated from a second flat surface 108 by a spacer 107. In this manner, the photonic waveguide 100 can form two separate waveguides. Of course, the waveguide 100 can omit either or both of the second flat surface 108 and the spacer 107.

As described briefly above, the photonic waveguide 100 illustrated in FIG. 1 can find application in communication from downhole devices, such as downhole sensors, to a surface location and vice versa. For example, in a completed well the photonic waveguide 100 can be integrated into or affixed to the casing and be used as a transmission medium for communication. In the context of drilling application, the photonic waveguide 100 can be integrated into or affixed to either the interior or the exterior of the drilling pipe and used to the same effect.

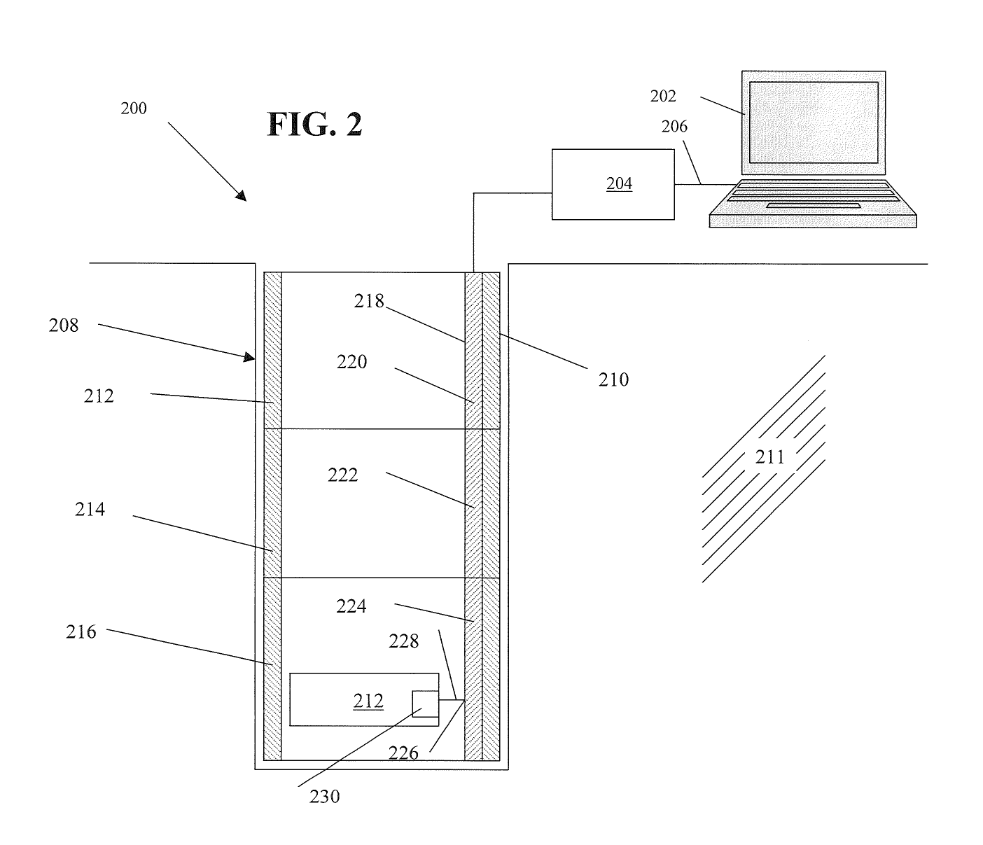

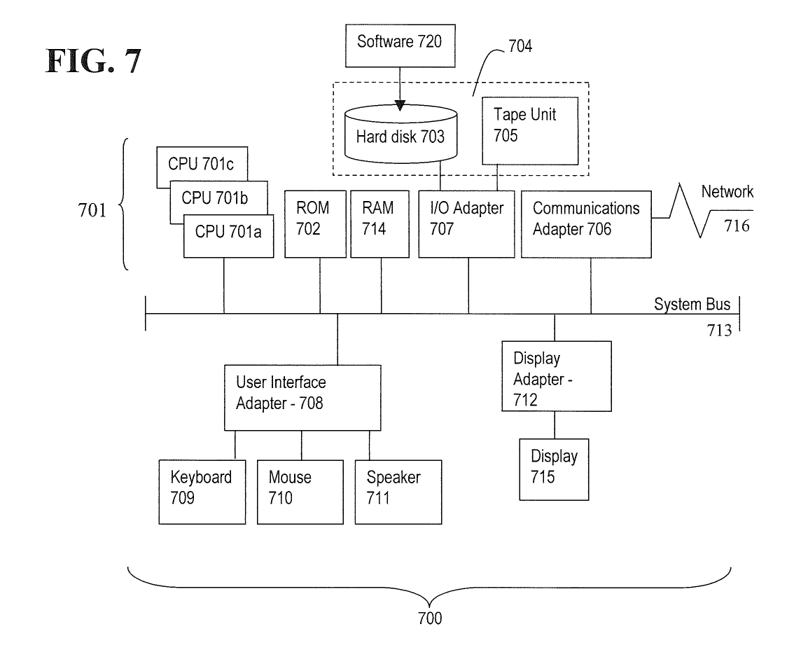

FIG. 2 shows an example downhole communication system 200 according to one embodiment. In this embodiment, the communication system 200 includes a computing device 202 that is located at a surface location. The computing device 202 can be any type of computing device. An example of a suitable computing device 202 is illustrated in more detail in FIG. 7.

The computing device 202 is coupled to a signal converter 204 by communication link 206. The signal converter 204 can be part of the computing device 202 in one embodiment. The signal converter 204 converts digital signals received from the computing device 202 into electromagnetic (EM) energy in one embodiment. In one embodiment, the signal converter 204 can receive EM energy from a source, convert it to a digital signal, and then provide it to the computing device 202. In one embodiment, the EM energy is one of: microwave frequency energy or radio frequency (RF) energy.

The system illustrated in FIG. 2 has portions disposed within a borehole 208 that penetrates the earth. The borehole 208 provides access to, for example, a formation 211 located below the surface of the earth. The formation 211 can include a hydrocarbon such oil or natural gas in one embodiment. It shall be appreciated, however, the teachings herein are not limited to use in the fields of exploration and production of hydrocarbons.

In one embodiment, the system 200 also includes one or more devices 212. As illustrated, the system is shown having a single device 212. Of course, the number of devices 212 is not limited as shown in FIG. 2. The device 212 can be any type of device that is provided to a location within the borehole 208. In one embodiment, the device 212 is a formation evaluation or directional sensor. In another embodiment, the device 212 is a sensor. Such a sensor may measure, for example, one or more of the stiffness of a drill string, friction experienced by the drill string, temperature, pressure, and the like.

In FIG. 2, the device 212 is illustrated as being located at a location within the borehole 208. The device 212 could be permanently located within the borehole 208 or could be lowered into, and subsequently removed from, the borehole 208. In the case where the device is lowered into borehole 208, the device 212 could be part of a sonde or a drill string.

The system 200 illustrated in FIG. 2 includes a downhole component 210 located within the borehole 208. In the illustrative example shown in FIG. 2, the downhole component 210 is casing and is shown in a cut-away view. The casing can be a large diameter pipe that is assembled and inserted into one or more sections of the borehole 210 in one embodiment. The casing may or may not be held in place with cement. The downhole component 210 includes a plurality of segments 212, 214, 216 in one embodiment. Of course, the downhole component 210 could be formed as a unitary member in one embodiment. While not clearly illustrated, it shall be understood that each segment 212, 214, 216 meets another segment at a junction.

In one embodiment, the downhole component 210 includes a photonic crystal waveguide (PCW) 218 coupled thereto. In one embodiment, the PCW 218 is fixedly attached to the downhole component 210. As illustrated, the PCW 218 is located on an interior portion of the downhole component 210. Of course, the PCW 218 could be located on an exterior portion of the downhole component 210 in one embodiment. In still another embodiment, the PCW 218 could be located between an inner and outer diameter of the downhole component 210.

As discussed above, the downhole component 210 can include a plurality of segments 212, 214, 216. As illustrated, each downhole component segment 212, 214, 216 includes a corresponding PCW segment 220, 222, 224. As illustrated, the PCW 218 is a strip. Of course, it could be formed as a tubular element in one embodiment.

According to one embodiment, the computing device 202 creates a digital signal that is converted to EM energy by the energy converter 204. The EM energy is coupled from the energy converter 204 into the PCW 218. Of course, the PCW is configured to pass EM energy having the frequencies in the range produced by the energy converter 204. Coupling energy into the PCW 218 shall be referred to from time to time herein as “launching.”

After the energy is launched into the PCW 218, it travels through the PCW in a generally downhole direction. At a communication tap location (leak region) 226 the EM energy is provided from the PCW 218 to the device 212 via communication link 228. Communication link 228 could be a wireless link in one embodiment. The device 212 includes a transmitter/receiver 230 that can receive the communication.

According to one embodiment, the device 212 creates a digital signal that is converted into EM energy and launched into the PCW 218 at the communication tap 226. In one embodiment, the conversion from the digital signal to the EM energy launched into the PCW 218 is performed by the transmitter/receiver 230. In such an embodiment, communication link 228 can be a wireless link. In one embodiment, the EM energy launched into the PCW 218 at the downhole location (i.e., at the location where the device 212 is located) is either RF or microwave energy. After being launched, the EM energy travels through the PCW 218 to the signal converter 204 where it converted to digital signal and provided to the computing device 202.

As illustrated, the signal converter 204 is shown at the surface. Of course, the signal converter 204 could be located at another location. For example, the signal converter 204 could be located within the borehole 208 in one embodiment. Furthermore, the signal converter 204 is illustrated as coupled by communication link 206 to the computing device 202. The communication link 206 can be wireless in one embodiment.

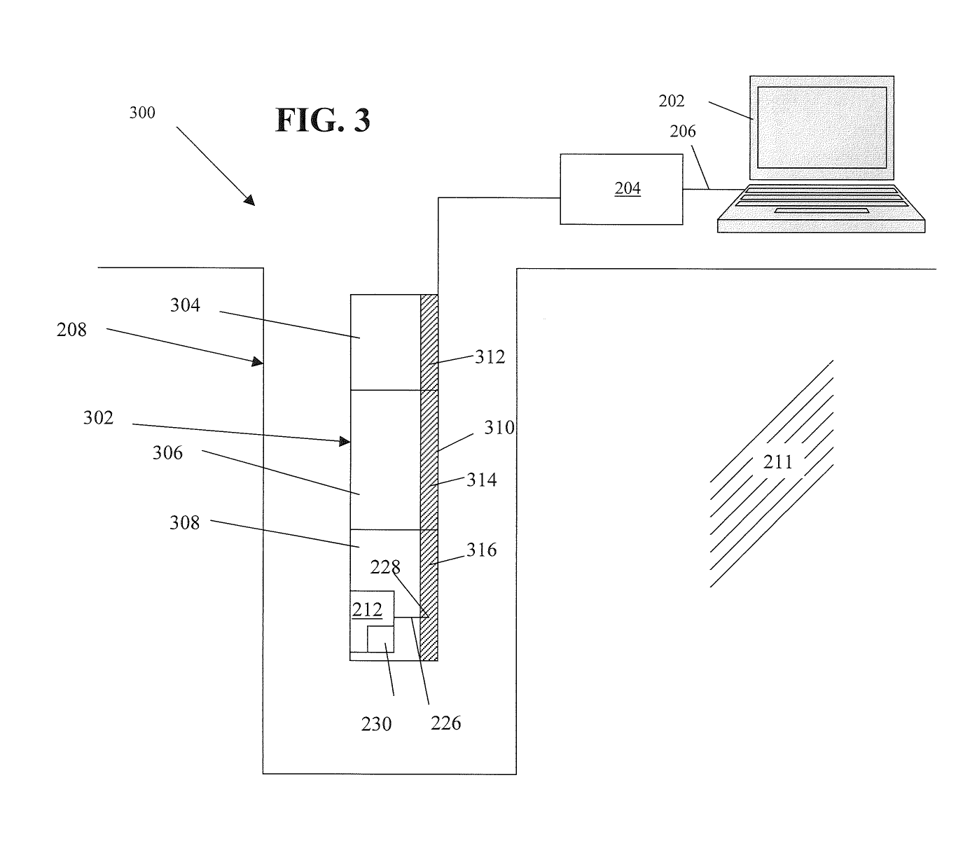

FIG. 3 shows another example downhole communication system 300 according to a different. In this embodiment, the communication system 300 includes a computing device 202 that is located at a surface location coupled to a signal converter 204 by communication link 206. In one embodiment, the computing device 202 and signal converter 204 are implemented in the same or similar manner as described above.

In this embodiment, the device 212 is located in or otherwise part of a downhole component 302. As illustrated, the downhole component 302 is a drill string and shall be referred to as such. The drill string 302 is formed by a plurality of segments 304, 306, 308. The segments 304, 306, 308 can be any type of element included in a typical drill string. For example, the segments could be a bottom hole assembly (BHA), a drill pipe, or a drill collar. Of course, the drill string 302 could be formed as a unitary piece in one embodiment. While not clearly illustrated, it shall be understood that each segment 304, 306, 308 meets another segment at a junction. Such a junction is typically referred to as a “joint coupling,” or more simply, as a “coupling,” in the industry.

In one embodiment, the downhole component 302 includes photonic crystal waveguide (PCW) 218 coupled thereto. In one embodiment, the PCW 218 is fixedly attached to the downhole component 302. As illustrated, the PCW 218 is located on an interior portion of the downhole component 302. Of course, the PCW 218 could be located on an exterior portion of the downhole component 302 in one embodiment. In still another embodiment, the PCW 218 could be located between an inner and outer diameter of the downhole component 302.

As discussed above, the downhole component 302 can include a plurality of segments 304, 306, 308. As illustrated, each downhole component segment 304, 306, 308 includes a corresponding PCW segment 312, 314, 316. As illustrated, the PCW 218 is a strip. Of course, it could be formed as a tubular element in one embodiment.

Communication between the device 212 and the computing device 202 shown in FIG. 3 can take place in the same or similar manner as described above with respect to FIG. 3.

It shall be understood that in one embodiment, the PCW is arranged on the segments of the downhole components disclosed herein in a such a manner that the guide region of a PCW on/in one segment can be aligned with the guide regions of a PCW on another segment.

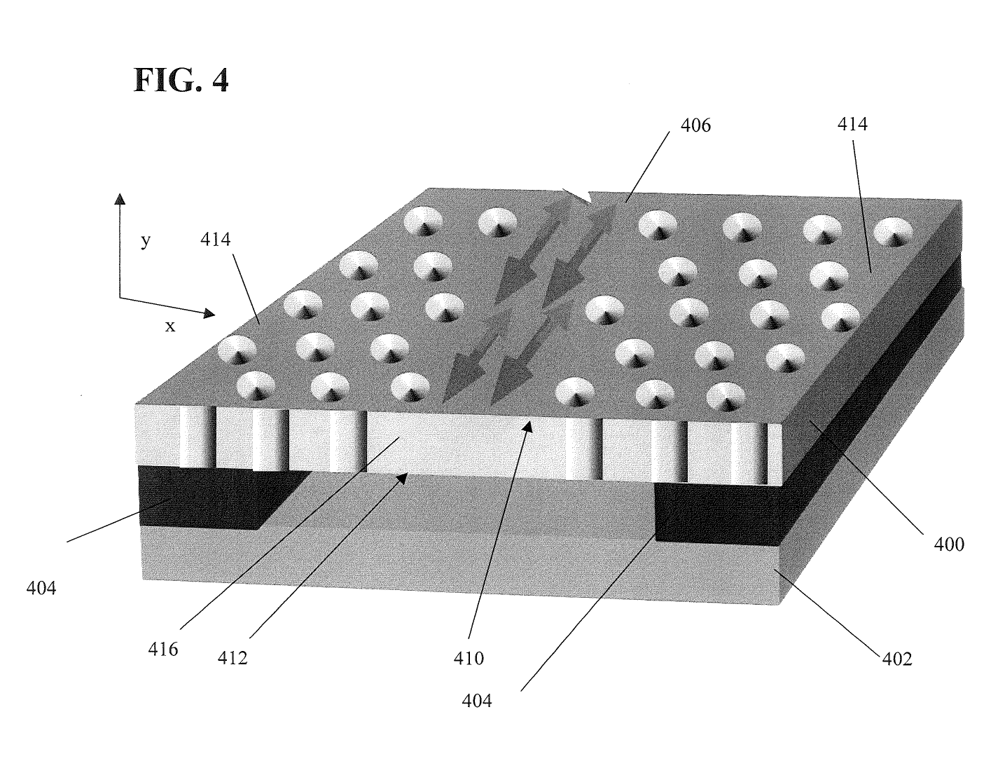

FIG. 4 shows a perspective view of a PCW 400 coupled to a downhole component 402. In this embodiment, the PCW includes a guide region 406. As illustrated, the guide region 406 provides for transmission of EM waves in either direction.

The PCW 400 of this embodiment is separated from the downhole component 402 by spacers 404. In one embodiment, the spacers 404 are arranged to ensure that the guide region 406 does not contact the downhole component 402. In this manner, EM energy traveling through the guide region is not transferred to the downhole component 402. Rather, the principle of total internal reflection bounds the EM energy such that it propagates in the “y” direction between the upper surface 410 and the lower surface 412 of the PCW 400. Reflection in the “x” direction is enforced by the blocking regions 414. Thus, the EM energy can travel in the “z” direction. In one embodiment, the PCW 400 is formed such that EM energy can radiate out from an endface 416 of the guide region. EM energy leaves the PCW 400 at the endface 416 and enters a leak region (not shown) that may include a different material than that which forms the PCW 400. For example, the leak region can include air, mud, drilling mud or other materials.

The leak region can be utilized to couple the EM energy in one PCW on one segment of a downhole component to a PCW on another segment of the downhole component. In this manner, the EM energy can traverse joints and may be able to allow for wireless communication from a downhole sensor to a surface location or vice-versa. That is, the EM energy can radiate out from the PCW and be wirelessly received by a downhole device. Alternatively, the downhole device can radiate or otherwise couple EM energy into the PCW and it can be transmitted towards the surface location.

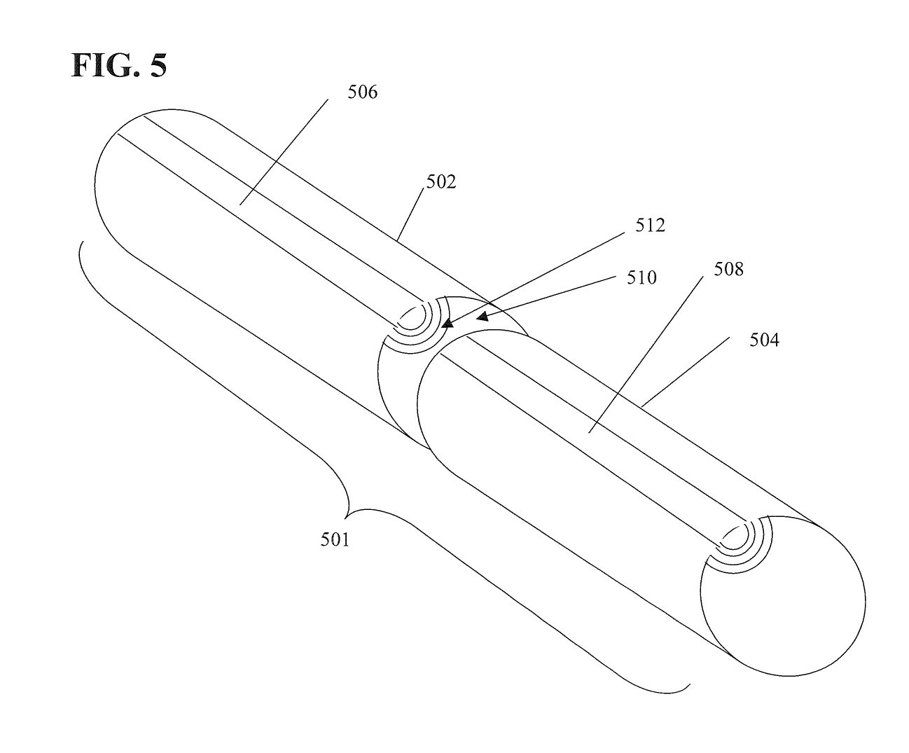

FIG. 5 shows an example of another system 500 according to one embodiment. The system 500 of this embodiment includes a downhole component 501 that is formed of a first portion 502 and a second portion 504. In one embodiment, the downhole component 501 is casing or a sandscreen. In another embodiment, the downhole component 501 is drill string and the first and second portions 502, 504 can be one of: a piece of drill pipe, a drill collar, or a bottom hole assembly. In this embodiment, the first portion 502 includes a first PCW 506 and the second portion 504 includes a second PCW 508. The PCWs 506, 508 can be located, as described, on an interior or exterior surface of their respective portions 502, 504.

As illustrated, the first portion 502 is separated from the second portion 504 by a leak region 510. Of course, in operation, the first portion 502 and the second portion 504 could be closely coupled to one another reducing the size of the leak region 510. Regardless of the size of the leak region 510, EM energy that is traveling along the first PCW 506 exits the PCW 506 at the leak region 510 as indicated by EM waves 512. The EM waves 512 traverse the leak region 510 and continue propagating along the downhole component 501 through the second PCW 508. At RF and microwave frequencies the interfaces between the first and second PCWs 506, 508 (e.g., leak region 510) may introduce losses. However, at these frequencies, portions 502 and 504 can be coupled within tolerances that maintain low losses between the PCWs 506, 508. In some cases, it may be beneficial to align the first PCW 506 to the second PCW 508 such that they are linearly oriented.

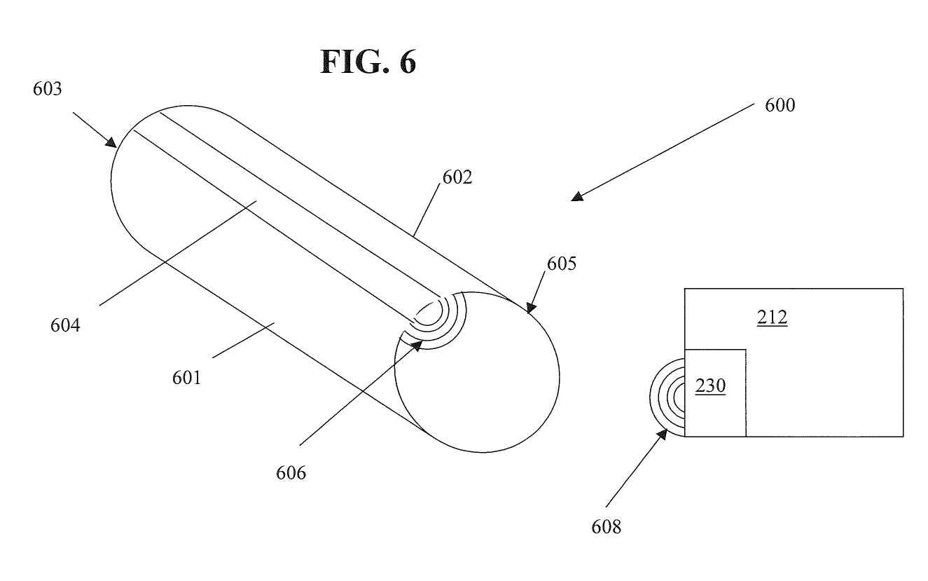

FIG. 6 shows a system 600 according to another embodiment. The system 600 of this embodiment includes a downhole component 602. The downhole component 602 includes a body portion 601 disposed between a first end 603 and a second end 605 of the downhole component 602. In one embodiment, the downhole component 602 is casing or a sandscreen. In another embodiment, the downhole component 602 is a portion of a drill string and can be one of: a piece of drill pipe, a drill collar, or a bottom hole assembly. In this embodiment, the downhole component 602 includes a PCW 604. The PCW 604 can be located, as described, on an interior or exterior surface of the downhole component 602.

The PCW 604 ends at a leak region that is located at or near and the second end 605 of the downhole component 602. In FIG. 6 the leak region is shown by the radiating EM waves 606. Of course, in this or any other embodiment disclosed herein, the PCW 604 could terminate or otherwise include a leak region where EM energy is allowed to leave or enter the PCW 604 anywhere along the length of the downhole component 602.

The system 600 also includes a device 212. The device 212 can transmit and receive EM waves through receiver/transmitter 230. In this manner, the device 212 can receive information from and launch information into the PCW 604.

In the above teachings it has been assumed that the EM energy can enter or leave the PCW unaided. One or more of the systems disclosed herein may include implements that allow EM energy to be launched into or received out of a PCW.

FIG. 7 shows an example of a computing system 700 that may form the computing device 202 shown in FIG. 1 and on which embodiments of the present invention may be implemented. In this embodiment, the system 700 has one or more central processing units (processors) 701a, 701b, 701c, etc. (collectively or generically referred to as processor(s) 101). Processors 701 are coupled to system memory 714 and various other components via a system bus 713. Read only memory (ROM) 702 is coupled to the system bus 713 and may include a basic input/output system (BIOS), which controls certain basic functions of the computing system 700.

FIG. 7 further depicts an input/output (I/O) adapter 707 and a network adapter 706 coupled to the system bus 713. I/O adapter 707 may be a small computer system interface (SCSI) adapter that communicates with a hard disk 703 and/or tape storage drive 705 or any other similar component. I/O adapter 707, hard disk 703, and tape storage device 705 are collectively referred to herein as mass storage 704. A network adapter 706 interconnects bus 713 with an outside network 716 enabling the computing system 700 to communicate with other such systems. A screen (e.g., a display monitor) 715 is connected to system bus 713 by display adaptor 712, which may include a graphics adapter to improve the performance of graphics intensive applications and a video controller. In one embodiment, adapters 707, 706, and 712 may be connected to one or more I/O busses that are connected to system bus 713 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 713 via user interface adapter 708 and display adapter 712. A keyboard 709, mouse 710, and speaker 711 can all be interconnected to bus 113 via user interface adapter 708, which may include, for example, a Super I/O chip integrating multiple device adapters into a single integrated circuit.

It will be appreciated that the system 700 can be any suitable computer or computing platform, and may include a terminal, wireless device, information appliance, device, workstation, mini-computer, mainframe computer, personal digital assistant (PDA) or other computing device. It shall be understood that the system 700 may include multiple computing devices linked together by a communication network. For example, there may exist a client-server relationship between two systems and processing may be split between the two.

Users of the system 700 can connect to the network through any suitable network interface 716 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 700 includes machine-readable instructions stored on machine readable media (for example, the hard disk 704) for capture and interactive display of information shown on the screen 715 of a user. As discussed herein, the instructions are referred to as “software” 720. The software 720 may be produced using software development tools as are known in the art. The software 120 may include various tools and features for providing user interaction capabilities as are known in the art.

In support of the teachings herein, various analysis components may be used, including a digital and/or an analog system. Further, various other components may be included and called upon for providing for aspects of the teachings herein. For example, a power supply (e.g., at least one of a generator, a remote supply and a battery), cooling component, heating component, motive force (such as a translational force, propulsional force or a rotational force), magnet, electromagnet, sensor, electrode, transmitter, receiver, transceiver, antenna, controller, optical unit, optical connector, optical splice, optical lens, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order. The term “couple” relates to two devices being either directly coupled or indirectly coupled via one or more intermediate devices.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A communication system for communicating between a device in a borehole penetrating a subsurface formation and a computing device at a surface location, the system comprising:
a downhole component having a portion near the device; and
a photonic crystal waveguide coupled to the downhole component, the photonic crystal waveguide configured to receive a signal from the device and guide it towards the computing device.

2. The communication system of claim 1, wherein the downhole component is a drilling pipe.

3. The communication system of claim 1, wherein the downhole component is a sandscreen or a borehole casing.

4. The communication system of claim 1, wherein the photonic crystal waveguide is configured to guide radio frequency (RF) electromagnetic (EM) energy.

5. The communication system of claim 1, wherein the photonic crystal waveguide is configured to guide microwave frequency electromagnetic (EM) energy.

6. The system of claim 1, further comprising:
the device, wherein the device is configured to convert a digital signal to electromagnetic (EM) energy and to direct the EM to the photonic crystal waveguide.

7. The system of claim 6, wherein the device is located at an end of the photonic crystal waveguide.

8. The system of claim 6, wherein the device is located proximate a leak region of the photonic crystal waveguide.

9. The system of claim 1, wherein the photonic crystal waveguide in formed by a plurality of photonic crystal waveguide portions.

10. The system of claim 9, wherein the downhole component is formed of a plurality of segments; and
wherein the plurality of segments each include a different one of the plurality of photonic crystal waveguide portions.

11. The system of claim 9, wherein the segments are joined at joints and wherein electromagnetic energy is transferred from one of the plurality of photonic crystal waveguide portions to another of the plurality of photonic crystal waveguide portions at the joints though a medium other than a photonic crystal waveguide.

12. A method of communicating from a downhole device located in a borehole penetrating a subsurface formation to a surface location, the method comprising:
coupling an electromagnetic (EM) signal from the device to a photonic crystal wave guide;
guiding the EM signal through the photonic crystal waveguide in a direction away from the device and towards the surface location;
converting the EM signal to a digital signal; and
providing the digital signal to a computing device at the surface location.

13. The method of claim 12, wherein guiding includes:
guiding the EM signal from the device to the surface location.

14. The method of claim 12, wherein coupling includes wireless coupling the EM signal from the device to the photonic crystal waveguide.

15. The method of claim 12, wherein the EM signal is a microwave or radio frequency (RF) signal.

16. The method of claim 12, wherein guiding includes:
guiding the EM signal to a first joint with a first portion of the photonic crystal waveguide; and
guiding the EM signal from the first joint to a second joint with a second portion of the photonic crystal waveguide, wherein the second portion does not contact the first portion.

17. A method of communicating from a computing device at a surface location to a downhole device located in a borehole penetrating a subsurface formation, the method comprising:
converting a digital signal created by the computing device into an electromagnetic (signal);
coupling an electromagnetic (EM) signal to a photonic crystal wave guide;
guiding the EM signal through the photonic crystal waveguide in a direction away from surface location and towards the device; and
receiving the EM signal at the device.

18. The method of claim 17, wherein guiding includes:
guiding the EM signal from the surface location to the device.

19. The method of claim 17, wherein receiving includes:
converting the EM signal to a digital signal at the device.

20. The method of claim 19, wherein the EM signal is received wirelessly.

21. The method of claim 17, wherein the EM signal is a microwave or radio frequency (RF) signal.

22. The method of claim 17, wherein guiding includes:
guiding the EM signal to a first joint with a first portion of the photonic crystal waveguide; and
guiding the EM signal from the first joint to a second joint with a second portion of the photonic crystal waveguide, wherein the second portion does not contact the first portion.

23. A downhole component comprising:
a body portion; and
a photonic crystal waveguide coupled to the body portion, the photonic crystal waveguide configured to receive a signal from a device.

24. The component of claim 23, wherein the body portion includes:
a first end; and
a second end;
wherein the photonic crystal waveguide extends from the first end to the second end.

25. The component of claim 23, wherein the photonic crystal wave guide includes a leak region where electromagnetic energy can enter or leave the photonic crystal waveguide.

26. The component of claim 25, wherein the leak region is located at an end of the body portion.

27. The component of claim 25, wherein the leak region is located a location other than an end of the body portion.
